(19) United States
(12) Patent Application Publication
(10) Pub. No.: US 2003/0225614 A1
(43) Pub. Date: Dec. 4, 2003

(54) World wide web document distribution system with compensation for document providers and for document receiving users for distribution costs by users permitting providers to track the users' document access activities on the web

(75) Inventors: Herman Rodriguez, Austin, TX (US); Robert R. Ruyle JR., Austin, TX (US)

Correspondence Address: International Business Machines Corporation, Intellectual Property Law Department, Internal Zip 4054, 11400 Burnett Road, Austin, TX, 78758, US

(73) Assignee: International Business Machines Corporation, Armonk, NY

(21) Appl. No.: 10/159,508

(22) Filed: May 30, 2002

(51) Int. Cl. G06F 17/60

(52) U.S. Cl. 705/14; 707/200

(57) ABSTRACT

In a World Wide Web network with user access via a plurality of data processor controlled interactive receiving Web display stations for displaying received hypertext documents accessible from document sources on the Web, a system for compensating Web document providers comprising means enabling a user at a receiving display station to bookmark a received Web document. When a document is thus bookmarked, the user is prompted to select to compensate a provider of said bookmarked document by permitting said provider to track said user's document access activities on the Web. Responsive to the prompting, there is an implementation for tracking the user's activities on the Web when the user selects to permit such tracking. This immediate current history of every hyperlink that the user has traversed in his path is fresh and dynamic and may be analyzed to focus on the user's dynamic and immediate interests. The information may be provided to appropriate sales and advertising organizations, and the resulting fees shared as compensation by the Web document providers and users.

### TECHNICAL FIELD

The present invention relates to computer managed communication networks, such as the World Wide Web (Web), and particularly to methods of compensating Web document providers and receiving users for the Web distribution costs.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web (the two terms are used interchangeably) related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct links between pages and other documentation on the Web and a variety of related data sources, which were, at first, text and then evolved into media, i.e. “hypermedia”. This even further exploded the use of the Internet or Web. The recent rapid expansion of the Web was to a great extent based upon giving user access to Web document sources without cost to the receiving user or at least without direct compensation to the document content providers maintaining Web sources. Many of such sources were maintained by government and academic institutions. In such cases, the compensation was the indirect combination of duty and goodwill that traditionally motivated such institutions to maintain libraries.

On the other hand, for the private business sector, the motivation for Web source content providers was a combination of goodwill, advertising, and the potential for acquiring customer business. While these motives have compensated many business organizations fairly well, the rapid expansion of Web user bases and the consequent great proliferation of “hits” and demands on Web sources is making the maintenance of Web sources commercially impractical for a great many business organizations.

Over the years advertising on the Web display has been used to generate compensation either directly to the content provider or by the collection of advertising revenue from general advertisers by Web service providers that subsequently distribute a portion of such revenue to the Web source content providers. The success of such general advertising on the Web has been quite limited, The interests of a user browsing on the Web are quite specific and personal while the advertising on the Web has been relatively general, unfocused and broadly directed.

In light of this situation, there have been efforts to direct advertising and the like to the specific interests of Web users. U.S. Pat. No. 6,324,566, dated Nov. 27, 2001, discloses a Web process wherein a user's bookmark collection is solicited for appropriate remuneration. Such a bookmark set is indicative of the user's cumulative interests and, thus, used by business organizations to focus their advertisement or other business contacts.

### SUMMARY OF THE PRESENT INVENTION

The present invention goes well beyond the focus of the above-referenced patent. Rather than just providing a stored bookmark picture of the users cumulative interests that may be traded for appropriate compensation, the present invention develops a dynamic picture of the user's current step-by-step browsing history on the Web. It also provides a dynamic user friendly method to enable the user to permit his content and service providers to access such browsing history and thereby compensate both the providers and user.

Accordingly, the present invention is directed to a Web network with user access via a plurality of data processor controlled interactive receiving Web display stations for displaying received hypertext documents of at least one display page containing text and images accessible from document sources on the Web. The invention provides a system for compensating Web document providers comprising means enabling a user at a receiving display station to bookmark a received Web document. When a document is thus bookmarked, prompting means prompt the user to select to compensate a provider of said bookmarked document by permitting said provider to track said user's document access activities on the Web; and there are means responsive to the prompting means for tracking said user's activities on the Web when the user selects to permit such tracking. This immediate current history of every hyperlink that the user has traversed in his path is fresh and dynamic and may be analyzed to focus on the user's dynamic and immediate interests. The information may be provided to appropriate sales and advertising organizations, with the resulting fees shared as compensation by the Web document providers.

In addition, the user may be compensated in that he continues to get his Web documents for free. The system may further include means for offering the user additional compensation for permitting a source content provider to track the user's Web document access activities. In such a situation, the user may be offered a first level of compensation to permit his data to be used anonymously for only statistical purposes and an additional level of compensation for permitting the information to be used for sales and advertising specially focused at the user.

In accordance with a further aspect of the invention, a Web server is provided for accessing Web documents from content provider sources for the user at the receiving display station, and this Web server includes the means for tracking said user's activities on the Web. In this manner, the tracked user history may be tracked and distributed by the user's Web Service Provider. The compensation to the user for permitting the tracking of his browsing history may be a waiver or reduction of the Service Provider fees.

The present invention may be most conveniently carried out by Web browsing means at said receiving display station including the means for bookmarking a received Web document, and the means for prompting said user to select to compensate the content provider of said bookmarked document by permitting said content provider to track said user's document access activities on the Web. This Web browser may also include means for caching a history list of the Web document sources accessed by the user at the receiving Web station, and the Web server may then include means for accessing this history list from said Web browser and for maintaining the list on behalf of the source content provider.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the receiving display station on which the received Web page or Web document may be processed by bookmarking in accordance with the present invention;

FIG. 2 is a generalized diagrammatic view of a Web portion upon which the present invention may be implemented;

FIG. 3 is a diagrammatic illustration of a display screen showing an initial Web document that may be bookmarked in accordance with the present invention;

FIG. 4 is the display screen of FIG. 3 showing the dialog box that appears after the user has selected to bookmark through which the user may select to permit the tracking of the user's accessing activities on the Web;

FIG. 5 is a another diagrammatic illustration of a display screen showing an initial Web document that may be bookmarked in accordance with the present invention;

FIG. 6 is the display screen of FIG. 5 showing the dialog box that appears after the user has selected to bookmark through which the user may select to permit the tracking of the user's accessing activities on the Web;

FIG. 7 is a general flowchart of a program set up to implement the present invention for permitting the tracking of the user's activities in accessing Web documents from Web sources and the compensating of both the Web document users and providers; and

FIG. 8 is a flowchart of an illustrative run of the program set up in FIG. 7.

### DETAILED DESCRIPTION OF THE PREFERRED EMBODIMENT

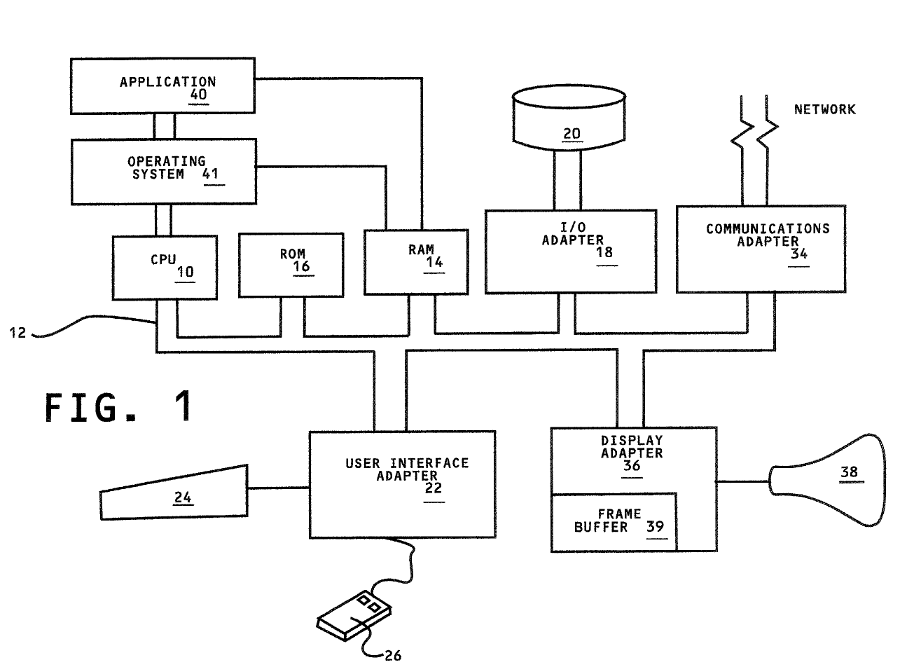

Referring to FIG. 1, a typical data processing terminal is shown that may function as a basic computer controlled Web receiving terminal used in implementing the present invention for permitting the tracking of the user's activities in accessing Web documents from Web sources and the compensating of both the Web document users and providers. The illustrative computer shown may also be used for the Web server provided by the Web Service Provider in the practice of the invention. A central processing unit (CPU) 10, such as one of the PC microprocessors or workstations, e.g. RISC System/6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs include the program of the present invention that will be described hereinafter in combination with any conventional Web browser at the receiving Web station, such as Netscape 6.0™ or Microsoft's Internet Explore™. Of course, when the illustrative computer of FIG. 1 is performing a Web server function, the program routines in applications 40 would be the programs involved in the tracking and storage of the history lists of the user's activities in accessing Web documents from Web sources and the tracking of any compensation that may be due to the Web document users, as well as the source content providers and the service providers themselves. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for bookmarking and bookmarked version selection at the receiving display terminal according to the present invention. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to documents, such as Web pages and media content therein, transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics, other images and audio. This displayable information may be still, in motion or animated, e.g. animated GIF images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. The images on the Web pages are implemented in a variety of image or graphic files such MPEG, JPEG or GIF files, which are described in the text, Internet: The Complete Reference, Millenium Edition, Young et al., 1999, Osborne/McGraw-Hill, particularly at pp. 728-730.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

The compensation involved in this invention would cover costs of the use of search engines for searching the various content provider sources on the Web. As described in the above-mentioned Internet: The Complete Reference, Millenium Edition text, pp. 395 and 522-535, search engines use keywords and phrases to query the Web for desired subject matter. In carrying out its search, the search engine looks through the database for matches to keywords subject to the engine syntax. The search engine then presents to the user a list of the Web pages it determines to be closest to the requested query. Some significant search engines are: AltaVista, Infoseek, Lycos, Magellan, Webcrawler and Yahoo. Of course, the paths traversed in carrying out such searches, as well as the users' criteria guiding such searches, would, on the other hand, provide data for the users' history lists provided in such compensation.

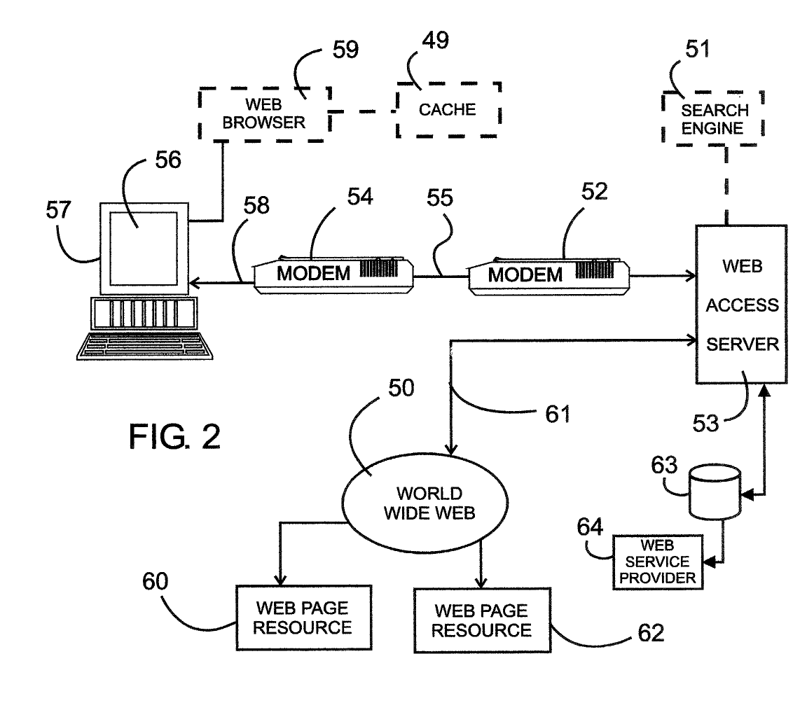

A generalized diagram of a portion of the Web, which the computer controlled display terminal 57 used for Web page receiving during searching or browsing, is connected as shown in FIG. 2. Computer display terminal 57 may be implemented by the computer system setup in FIG. 1 and connection 58 (FIG. 2) is the network connection shown in FIG. 1. For purposes of the present embodiment, computer 57 serves as a Web display station and has received displayed Web page 56, which is one of a sequence of Web pages containing embedded hyperlink to other Web pages or documents. It is the user's path from Web document (page) to Web document (page), both directly tracked and backtracked that is recorded in the user's history list that is dynamically compiled, as will be hereinafter described in greater detail.

Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years through network access servers 53 that are linked 61 to the Web 50. The Web servers 53, which also may have the computer structure described with respect to FIG. 1, may be maintained by a Web Service Provider to the client's display terminal 57. The Web server 53 is accessed by the client terminal 57 through a normal dial-up telephone linkage 58 via modem 54, telephone line 55 and modem 52. Any conventional digital or analog linkages, including wireless connections, are also usable. The HTML file representative of the Web page 56 has been downloaded to display terminal 57 through Web access server 53 via the telephone line linkages from server 53, which may have accessed the file from the Web 50 via linkage 61. The Web browser program 59 operates within the display terminals 57 to control the communication with the Web access server 53 to thereby download and display the accessed Web pages 56 on terminal 57. The Web access server 53 uses one of the previously described search engines 51 to access via the Web 50 the desired sequence of Web pages from appropriate Web sources, such as databases 60 and 62. Web server 53 will carry out the functions of obtaining the user's history lists, which have been dynamically compiled by browser 59 and stored in browser cache 49. When the user has permitted the tracking of his Web browsing activities, then the history list of each browsing session is stored in cache 49. Periodically, and/or conveniently at the end of the browsing session, the history list in cache 49 is transmitted to database 63 maintained by the Web Service Provider in association with Web server 53. This data is then available to be used by the Web Service Provider 64 for appropriate distribution to marketing and sales organizations for appropriate compensation, which may then be tracked and distributed most conveniently by the Web Service Provider, respectively, to users and Web document providers.

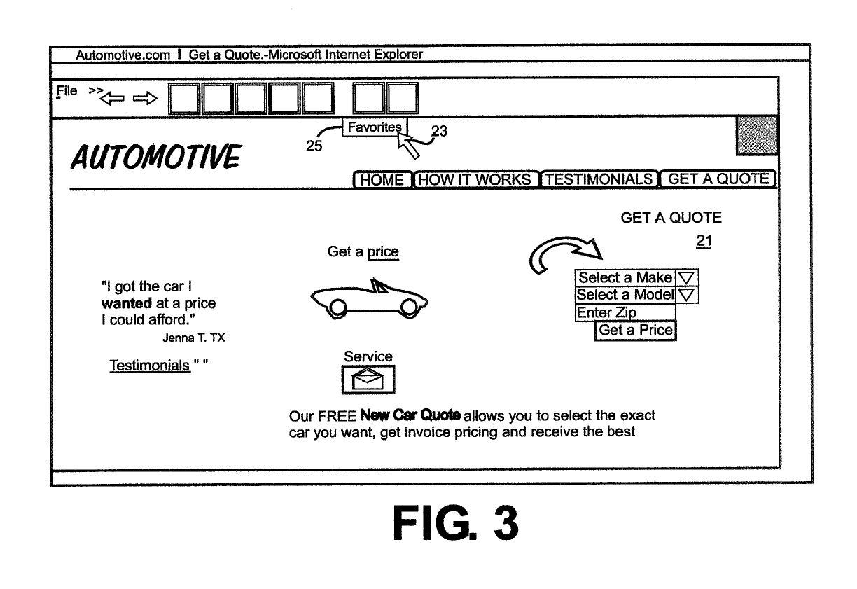

With this setup, the present invention, which will be described in greater detail with respect to FIGS. 3 through 6, may be carried out using Web browser 59 and associated Web server 53 (FIG. 2). Search engine 51 accesses the sequence of Web pages and provides such pages to the user at terminal 57 via Web browser 59 via server 53.

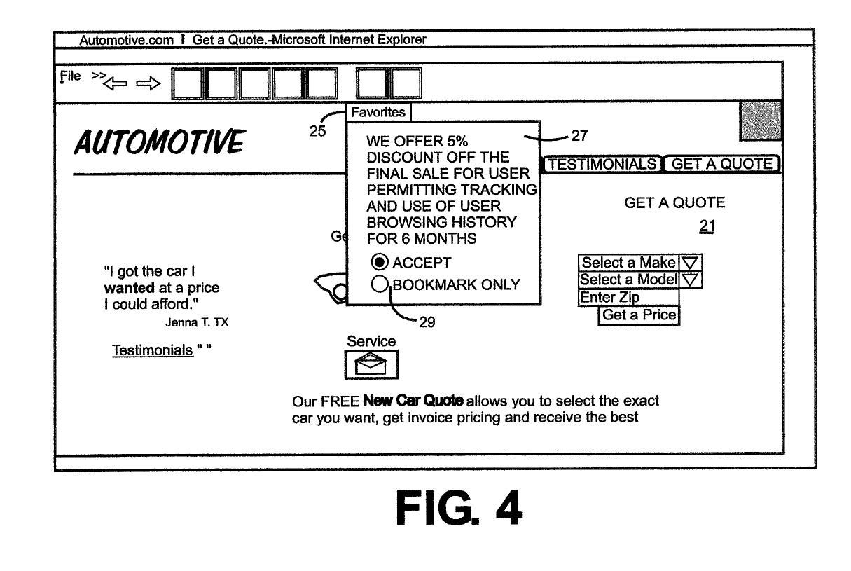

FIGS. 3 through 6 provide an illustrative example of how the present invention may be used to offer the user appropriate compensation for tracking and compiling a history list of the user's sequential accessing of Web documents to be referred to as Web pages. Web page 21, FIG. 3, is an illustration of the displayed Web page 56 in FIG. 2. This standard page contains text, graphics and images, as well as hyperlinks to other Web pages. At the stage shown in FIG. 3, the user has decided to bookmark Web page 21 for future reference thereto. He has moved his pointer 23 to the bookmark item 25 and clicked on it. As a result, FIG. 4, dialog box 27 is displayed. The bookmarking of Web page 21 has indicated an interest in the possible purchase of an automobile. As a result, the various Web sites and sources that the user will then visit will have obvious marketing value to a variety of automobile organizations. Thus, the user is offered compensation, i.e. a 5% discount off his potential sales price for a subsequently bought automobile, to permit the tracking of his Web browsing activities. The user is then given a set of data entry prompts 29 whereby he may accept the offer to permit tracking. In such a case, the browser will commence compiling and processing the previously mentioned user Web activity history list. Alternatively, the user may select “Bookmark Only”; he will get a conventional bookmark but without the 5% discount compensation.

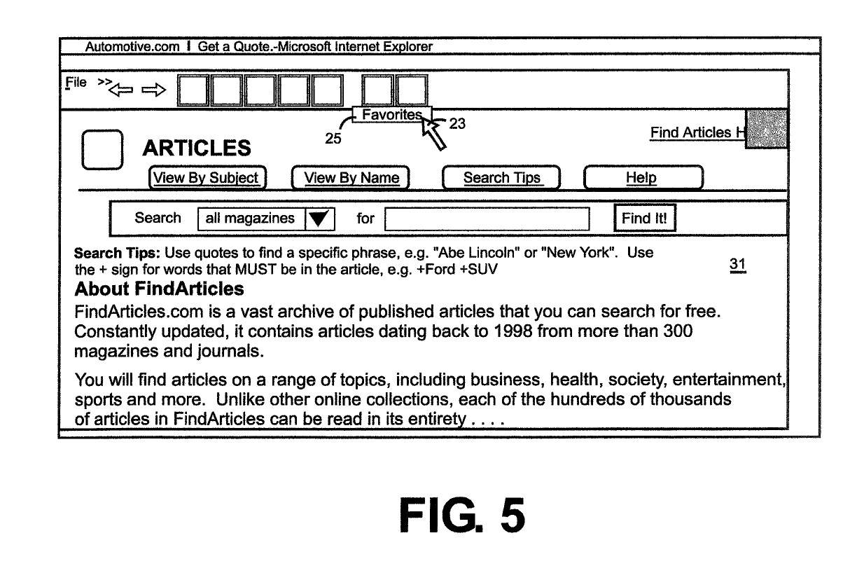

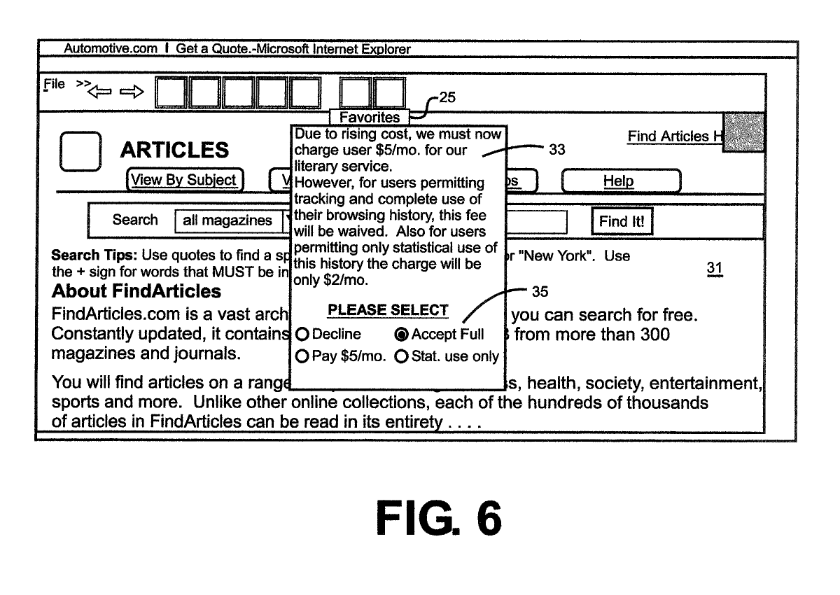

FIGS. 5 and 6 cover a variation wherein the user is given some further options in the tracking and compiling of his Web activity lists and their uses. At the stage shown in FIG. 5, the user has decided to bookmark Web page 31 for future reference thereto. He has moved his pointer 23 to the bookmark item 25 and clicked on it. As a result, FIG. 6, dialog box 33 is displayed. The bookmarking of Web page 21 has indicated an interest in scientific articles. However, the Web source content provider, following recent Web industry trends no longer offers free access to his Web documents. The source content provider has to charge $5.00 per month for the service. However, the user is offered compensation options to permit the tracking of his Web browsing activities. The user is given a set of data entry prompts 35 offering these options whereby he may accept the offer to permit full tracking. In such a case, the browser will commence compiling and processing the previously mentioned user Web activity history list, and the provider is free to use the data for any marketing purpose, e.g. direct marketing to the user by vendors. The user will be compensated by having the $5.00/mo. fee fully waived. Alternatively, the user may select “Stat. Use Only”. Then, the user will get limited compensation of a $2/mo. discount but his Web activity lists will only be used for statistical purposes; the user will remain anonymous. Lastly, the user may select “Decline”, to decline the compensation. In such a case, he may still get a conventional bookmark but he will have to agree to the $5.00/mo. compensation to the provider.

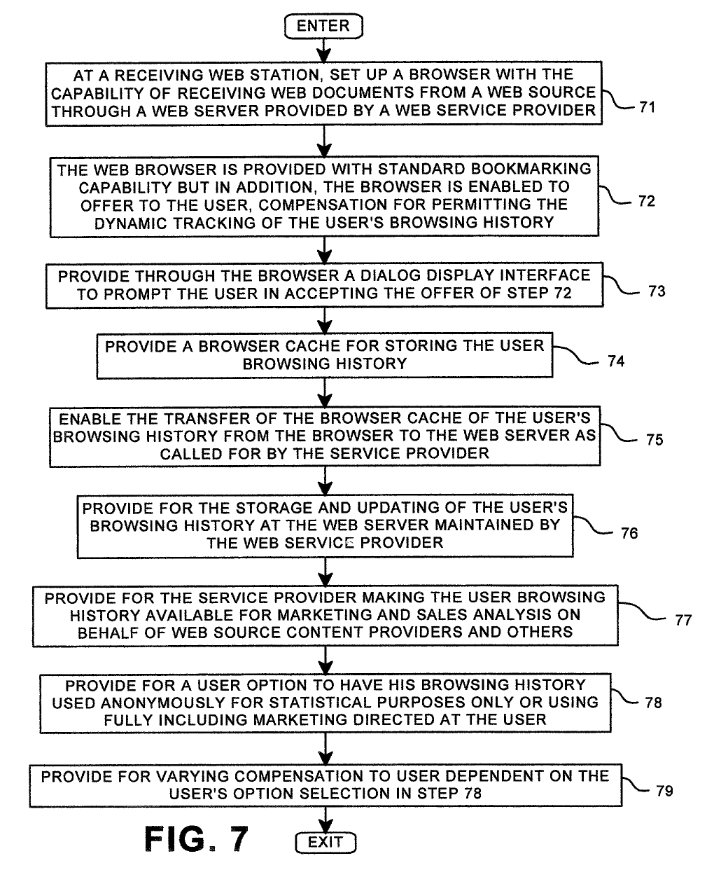

FIG. 7 is a flowchart showing the development of a process according to the present invention for enabling a user to permit dynamically recording a history of his browsing activities in return for compensation. Most of the programming functions in the process of FIG. 7 have already been described in general with respect to FIGS. 3 through 6. A Web browser is provided at a receiving display station on the Web for accessing Web pages in the conventional manner and loading them at the display station, step 71. The Web pages are conventionally obtained via a Web server provided by a Web Service Provider. The Web browser has the capability of requesting searches from one or more search engines available through the Web. A process is provided to give the Web browser standard bookmarking capabilities, but, in addition, the browser is enabled to offer to the user compensation for permitting the dynamic tracking of the user's browsing history, step 72. Through the browser, step 73, the user is presented with a dialog box display interface to prompt the user in the acceptance of the offer of step 72. A browser cache is provided for storing a user's browsing history, step 74. There is a set up to enable the transfer from the browser cache, the user's browsing history, to the Web server as called for by the Web Service Provider, step 75. A database is provided in association with the Web server for the storage and updating of the user's browsing history under the maintenance and control of the Web Service Provider, step 76. Provision is made for the Web Service Provider to be empowered to make the user browsing history available for marketing and sales analysis on behalf of the Web document providers, as well as anyone else who will pay for such information subject to the contractual obligations between the providers and users, step 77. A user option is also provided for a user to select to have his browsing history used anonymously for statistical purposes only, or to be used fully including marketing directed at the user, step 78. Accordingly, varying compensation is provided, step 79, dependent on the user's option in step 78.

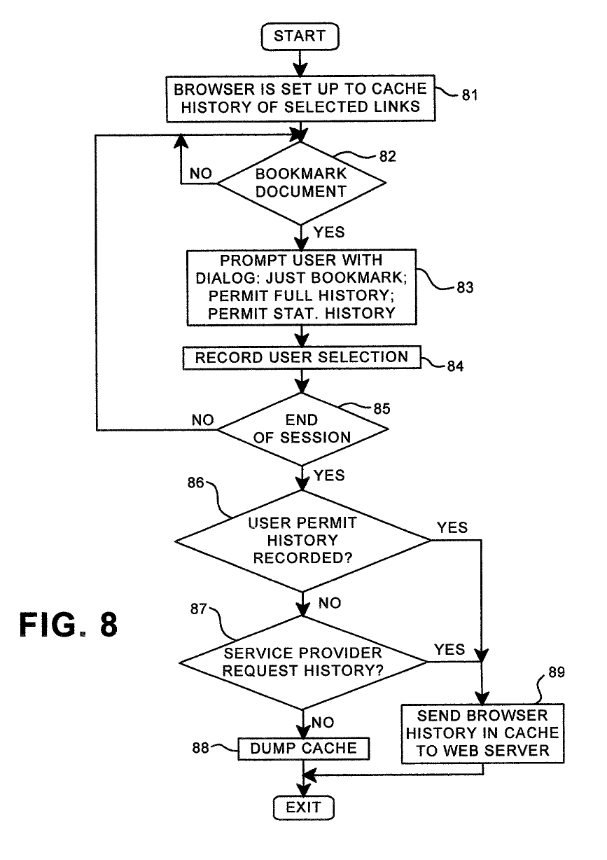

The running of the process set up in FIG. 7 and described in connection with FIGS. 3 through 6 will now be described with respect to the flowchart of FIG. 8. First, the Web Browser is set up to cache a history list of every selection and link made by the user during the browsing session, step 81. Let us assume that we are in a Web browsing session through the browser. The flowchart represents some steps in a routine that will illustrate the operation of the invention. The browser, via the Service Provider Web server, accesses the pages found by a search engine; the next Web page is accessed, and a determination is made as to whether the user has bookmarked the page, step 82. If No, the process is returned to step 82 and the next page is awaited. If Yes, the user elects to bookmark the Web page, the user is offered the options, step 83, via a dialog box of either only conventionally bookmarking, permitting the recording and full use of the user's browsing history or recording but using the history for statistical purposes only. The user's selection is then recorded, step 84. A determination is then continuously made as to when the browsing session is ended, step 85. If No, the process is returned to step 82 wherein the browsing session is continued. If Yes, the browsing session is at an end, then a determination is made, step 86, as to whether the user has permitted the use of his history. Then, if Yes, the user history in the browser cache is transferred to the Web server database for storage and use, step 89. If the determination of step 86 is No, the user has not made this choice in the current session, it may still be the case that the user already has a previously made obligation to have his browser history tracked and stored. In such a case, the Web Service Provider will be maintaining this function. Consequently, step 87, a determination is made as to whether the Web Service Provider is requesting the user's history list. If Yes, then the user history in the browser cache is also transferred to the Web server database for storage and use, step 89. If the determination in step 87 is No, the user history list in the browser cache is disregarded. In either case the browser session is exited.

One of the preferred implementations of the present invention is in application program 40, i.e. a browser program made up of programming steps or instructions resident in RAM 14, FIG. 1, of a Web receiving station and/or Web server during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

While the embodiment of the present invention offers the user compensation options when the user indicates his areas of interest through bookmarking, these options may be offered to users at other stages of Web usage. Actually the user may be prompted to select to permit tracking of the users' Web access history in return for appropriate Web compensation.

Although certain preferred embodiments have been shown and described, it will be understood that many changes and modifications may be made therein without departing from the scope and intent of the appended claims.

What is claimed is:

1. In a World Wide Web (Web) communication network with user access via a plurality of data processor controlled interactive receiving Web display stations for displaying received hypertext documents of at least one display page containing text and images accessible from document sources on the Web, a system for compensating Web document providers comprising:
means enabling a user at a receiving display station to bookmark a received Web document;
prompting means associated with the bookmarking of a Web document by a user for prompting said user to select to compensate a provider of said bookmarked document by permitting said provider to track said user's document access activities on the Web; and
means responsive to said prompting means for tracking said user's activities on the Web.

2. The Web system of claim 1 further including means for offering the user additional compensation for permitting a source content provider to track the user's Web document access activities.

3. The Web system of claim 2 further including:
a Web server for accessing Web documents from content provider sources for said user at said receiving display station; and
said Web server including said means for tracking said user's activities on the Web.

4. The Web system of claim 3 wherein said Web server is maintained by a Web Service Provider.

5. The Web system of claim 3 further comprising:
Web browsing means at said receiving display station including:
said means for bookmarking a received Web document; and
said means for prompting said user to select to compensate the content provider of said bookmarked document by permitting said content provider to track said user's document access activities on the Web.

6. The Web system of claim 5 wherein said Web browsing means further includes:
means for caching a history list of the Web document sources accessed by the user at the receiving Web station; and
said Web server includes means for accessing said history list from said Web browsing means, and for maintaining said list on behalf of the source content provider.

7. The Web system of claim 6 wherein:
said Web server is maintained by a Web Service Provider; and
said additional compensation offered to the user is a reduction in the Service Provider's user fees.

8. In a Web communication network with user access via a plurality of data processor controlled interactive receiving Web display stations for displaying received hypertext documents of at least one display page containing text and images accessible from document sources on the Web, a method for compensating Web document providers comprising:
enabling a user at a receiving display station to bookmark a received Web document;
prompting the user of a bookmarked Web document to select to compensate a provider of said bookmarked document by permitting said provider to track said user's document access activities on the Web; and
tracking said user's activities on the Web responsive to said user selection to permit said tracking.

9. The method of claim 8 further including the step of offering the user additional compensation for permitting a source content provider to track the user's Web document access activities.

10. The method of claim 9 wherein said network further includes a Web server for accessing Web documents from content provider sources for said user at said receiving display station; and said step of tracking said user's activities on the Web is carried out in said Web server.

11. The method of claim 10 wherein said Web server is maintained by a Web Service Provider.

12. The method of claim 10 further comprising:
a Web browsing process at said receiving display station including said steps of:
bookmarking a received Web document; and
prompting said user to select to compensate the content provider of said bookmarked document by permitting said content provider to track said user's document access activities on the Web.

13. The method of claim 12 wherein said Web browsing process further includes the steps of:
caching a history list of the Web document sources accessed by the user at the receiving Web station; and
accessing said history list from said Web browsing process, and maintaining said list on behalf of the source content provider at said Web server.

14. The method of claim 13 wherein:
said Web server is maintained by a Web Service Provider; and
said additional compensation offered to the user is a reduction in the Service Provider's user fees.

15. A computer program having code recorded on a computer readable medium for compensating Web document providers in a Web communication network with user access via a plurality of data processor controlled interactive receiving Web display stations for displaying received hypertext documents of at least one display page containing text and images accessible from document sources on the Web, said program comprising:
means enabling a user at a receiving display station to bookmark a received Web document;
prompting means associated with the bookmarking of a Web document by a user for prompting said user to select to compensate a provider of said bookmarked document by permitting said provider to track said user's document access activities on the Web; and
means responsive to said prompting means for tracking said user's activities on the Web.

16. The computer program of claim 15 further including means for offering the user additional compensation for permitting a source content provider to track the user's Web document access activities.

17. The computer program of claim 16 wherein the Web network further includes:
a Web server for accessing Web documents from content provider sources for said user at said receiving display station; and
said Web server including said means for tracking said user's activities on the Web.

18. The computer program of claim 17 wherein said Web server is maintained by a Web Service Provider.

19. The computer program of claim 17 further comprising:
a Web browser program at said receiving display station including:
said means for bookmarking a received Web document; and
said means for prompting said user to select to compensate the content provider of said bookmarked document by permitting said content provider to track said user's document access activities on the Web.

20. The computer program of claim 19 wherein said Web browser program further includes:
means for caching a history list of the Web document sources accessed by the user at the receiving Web station; and
said Web server includes means for accessing said history list from said Web browsing means, and for maintaining said list on behalf of the source content provider.

21. The computer program of claim 20 wherein:
said Web server is maintained by a Web Service Provider; and
said additional compensation offered to the user is a reduction in the Service Provider's user fees.
